(19) United States
(12) Patent Application Publication
(10) Pub. No.: US 2008/0230614 A1
(43) Pub. Date: Sep. 25, 2008

(54) Credit card security enhancement

(76) Inventor: Adam Rousseau Boalt, West Palm Beach, FL (US)

Correspondence Address: MAYBACK & HOFFMAN, P.A., 5722 S. FLAMINGO ROAD #232, FORT LAUDERDALE, FL, 33330, US

(21) Appl. No.: 11/256,441

(22) Filed: Oct. 24, 2005

(51) Int. Cl. G06K 19/067

(52) U.S. Cl. 235/492

(57) ABSTRACT

The credit card security enhancement is a combination credit and security card that has the same size dimensions as a credit card and can be used in conventional credit card swiping terminals, ATMs, and so on. It contains an enhanced, digital, liquid crystal display (LCD) screen that displays a distinct identification number, generated randomly every 60 seconds by an embedded microprocessor, which is used as a security pin or password. A powerful identification authenticator generates a new identification code every minute by combining the use of a distinct symmetric key and powerful algorithm. The continually changing identification code allows a merchant to authorize one distinct transaction or event. An enhanced, lithium polymer battery powers the dynamic, digital authentication code.

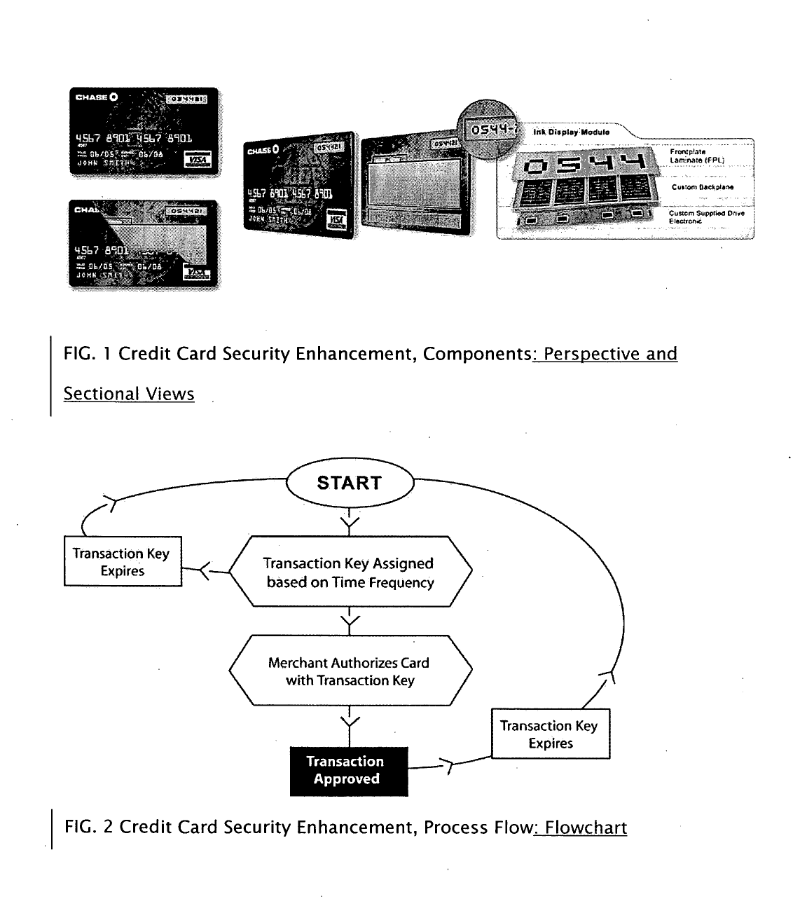

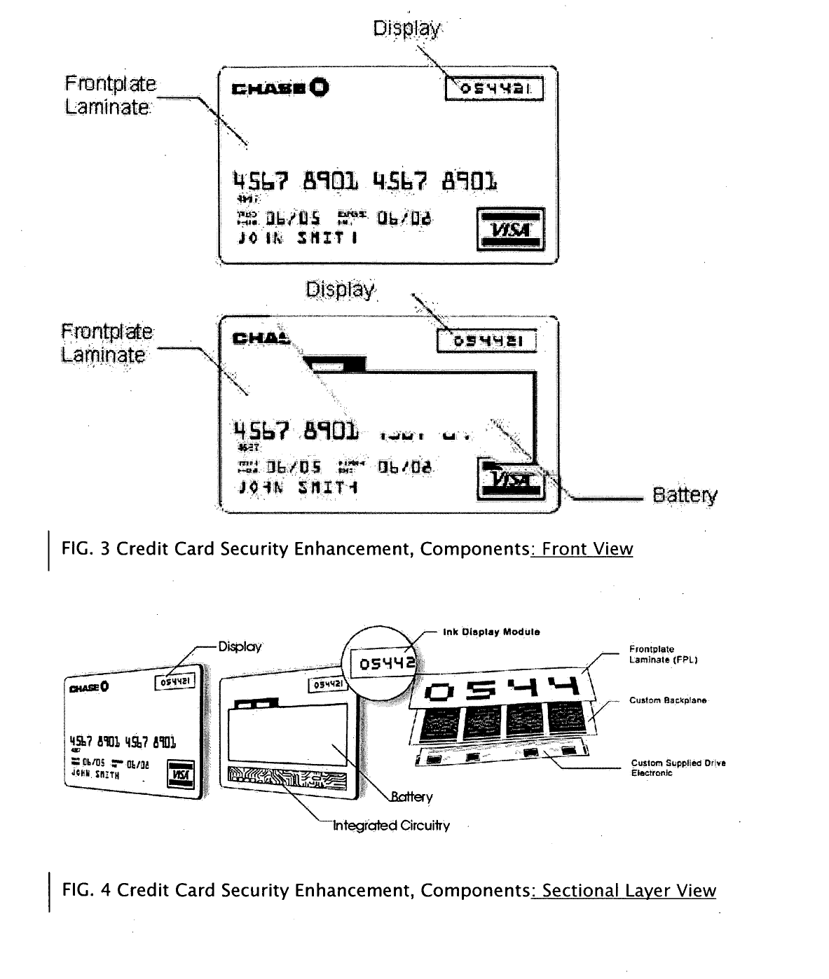

### HISTORY

Named after the small plastic card issued to consumers, a credit card is a settlement for a transaction on credit. A credit card represents a loan from the credit card issuer to the credit card user. Most credit cards have a standard (ISO 7810) shape and size.

American merchants first started using credit cards in the 1920's, procuring each other's goods and services. For the consumer, 1950 saw the first credit card issued by Diners' Club, followed by American Express in 1958. Bank of America issued the BankAmericard (now Visa), the first bank credit card, in 1958. Traveling salesmen, the main target audience, used them on the road.

By the 1960s, more companies offered credit cards, advertising them as a time-saving device rather than a form of credit. American Express and MasterCard became huge successes overnight, and by the mid-'70s, Congress had to start to regulate the credit card industry by banning such practices as the mass mailing of active cards to those who had not requested them.

Conventional credit cards invite fraud. An unauthorized user can steal the credit card account number from a misplaced card on a checkout counter or from a discarded receipt. The unauthorized user can then use the card's account number to buy almost anything at anytime. Credit card companies bleed millions of fraud dollars every year. Furthermore, insurance companies try to stanch the bleeding with ever-expensive band-aids.

Credit card fraud is on the rise. As an example of the pervasiveness of credit card fraud, restaurant and service station employees are being paid between $200 and $300 for every ‘skimmed’ credit card. Special portable hand-held devices are used to swipe customers' cards. The card information is then stored on a disk or PC for the manufacture of counterfeit versions.

Even credit card receipts in the wrong hands invite fraud. Bank and credit card company's electronic databases can reasonably secure money accounts but are still vulnerable to credit account bandits and hackers.

Credit card security is continually being improved and includes:
on-line verification, 4 digit Personal Identification Number or PIN
smart cards containing microprocessors
3 or 4 digit address verification system (AVS)

### DEFINITION OF ENHANCEMENT

This credit card security enhancement aims to replace conventional credit cards. It is used like a conventional credit card, but only the look and processing of the transaction differ. Most consumer transactions can be performed more securely with this new card. The purchaser need only supply his or her 4- to 8-digital identification number to a merchant. As a result, credit card fraud is greatly minimized.

Credit security applications include:
Credit cards
Electronic cash
Computer security systems
Wireless communication
Loyalty systems (like frequent flyer points)
Banking
Satellite TV
Government identification

### FEATURES AND BENEFITS

This credit card security enhancement looks like a credit card and even shares the same size dimensions but, again, the physical content of the card is different and is discussed below. The main feature of the card is security, which is evidenced by an enhanced LCD screen.

This new card uses identification authenticators that assign a token to a user, and the token generates a distinct and random personal identification code automatically every 60 seconds. A powerful algorithm when combined with the authenticator's distinct and symmetric key, generates each new time-based code. A number is valid at that moment in time for that user/authenticator combination after the authenticator manager validates the new number. Combined with a secret Personal Identification Number (PIN), the new number adds another layer of security, allowing the user to log into protected sites and resources.

The embedded microprocessor in the card primarily exists for identification security. The microprocessor enforces access to data on the card. It enforces access to data by time-based, self-authenticating algorithms that communicate with a host computer much like a child communicates to the parent.

As mentioned before, the credit card system presents many opportunities for fraud due to inherent, relatively low security. Millions of dollars are spent by banks, credit card issuers, merchants, and insurance companies every year resolving credit theft. In 2004, banks and merchants lost more than two billion dollars to fraud. This credit card enhancement greatly reduces both consumer and merchant credit theft by the use of constantly changing code (or dynamic algorithm authenticator), which adds another layer of security.

Each card, transaction security code is unique. As a result, it becomes extremely difficult to hack or guess the correct security code at any given place or time, thereby dramatically curtailing credit fraud. Most fraud could be eliminated by a two- or three-tier ID authentication system with debit and credit purchases, e.g., a secure ID and password for credit purchases.

Again, this credit card security enhancement is a form of credit security card that is the same size as a credit card but contains an enhanced, digital, liquid crystal display (LCD) screen, embedded microprocessor and battery. The enhanced LCD screen displays a self-generated (every minute), identification security code.

This code is used to secure a transaction. The code allows credit transfer between merchant and customer, and identifies the transaction but not the transactor. Thus, the credit transaction's security environment is distinct and unique to itself. The preceding identification code is not used for subsequent transactions. The customer's credit identity remains safe because his or her identification code will change with the next transaction.

An application example may include banks that require intermittent changes in user name and password for bank-issued check cards. A digital pin number or identification code would be another added, inherent layer of security for the user.

The new card uses a new battery technology that is ultra-thin, flexible, environmentally friendly, safe, and made of a lithium polymer. This new battery technology provides on-board battery power to radio frequency identification devices (RFID) such as tags, cards, and labels, and thin-film medical products such as transdermal delivery of medicines.

Lithium is a soft, silvery, highly reactive metallic element that is used as a heat transfer medium. When combined with highly reactive polymers or natural or synthetic compounds, the lithium battery provides maximum performance in a small, thin package. The battery will not break or crack when bent or flexed. You can drive a nail through the center of the battery and it will still retain optimal performance and life. It is safe, non-toxic, and operates at temperatures between −10° C. to 60° C.

The LCD screen display can be made by the development of new types of flexible displays including organic thin film transistor-liquid crystal displays, electrophoretic, plasma, and Organic Light Emitting Diode (OLED) displays.

For example, OLED displays contain sandwiched layers of organic material between two electric connectors. When a charge is applied to one connector, it flows through the organic material, causing it to glow.

The enhanced LCD screen contains millions of tiny white positive and black negative microcapsules, painted and suspended on a thin bed of circuitry, that interact in a clear fluid when negatively or positively charged. As a result almost any surface can become an information display. No backlight is needed and so the entire display panel can be made thinner, lighter, and will require less power than an equivalent LCD.

The physical face of the new card is ergonomically and intuitively designed making it easy and convenient to use.

1. A device for securing an account, the device comprising:
a credit-card sized medium that includes a set of characters identifying an account;
an electronic code generator embedded at least partially within the medium, the code generator adapted for generating a temporary time-based code, the temporary time-based code being dependent upon a current time; and
a code presenter adapted to present the temporary time-based code.

2. The device according to claim 1, the code presenter comprising:
a display for displaying the temporary time-based code.

3. The device according to claim 2, wherein the display is a liquid crystal display screen.

4. The device according to claim 1, wherein the temporary time-based code is verifiable by a third-party authenticator to allow access to the identified account.

5. The device according to claim 1, wherein the temporary time-based code is valid for only one use.

6. The device according to claim 1, wherein the temporary time-based code is generated from a token.

7. The device according to claim 1, wherein the temporary time-based code is generated from a symmetric key.

8. The device according to claim 1, wherein the electronic code generator is a processor.

9. The device according to claim 1, wherein the time-based code includes a plurality of numbers.

10. The device according to claim 1, further comprising:
a lithium polymer battery coupled to the electronic code generator for providing power to the electronic code generator.

11. A method for securing an account, the method comprising:
generating with an electronic number generator embedded within a credit-card sized medium, a temporary time-based code that is dependent upon a time of day;
presenting the temporary time-based code; and
transmitting the temporary time-based code to an account-validating party.

12. The method according to claim 11, further comprising:
transmitting a permanent account identification number to the account-validating party.

13. The method according to claim 11, further comprising:
transmitting a personal identification code to the account-validating party.

14. The method according to claim 11, further comprising:
receiving an indicator indicating that a transaction was approved based at least in part on the transmitted time-based code.

15. The device according to claim 11, wherein the temporary time-based code is verifiable by a third party as a password.

16. The device according to claim 11, wherein the temporary time-based code is valid for only one use.

17. The device according to claim 11, wherein the temporary time-based code is generated from a symmetric key.

18. A method for authorizing access to an account, the method comprising:
receiving a plurality of characters identifying an account;
receiving a time-based code generated by an electronic number generator embedded at least partially within a credit-card sized medium; and
authorizing a transaction, where the authorization is based at least partially on authorization of the time-based code based upon a time of day.

19. The method according to claim 18, wherein the authorization is performed by comparing the time-based code to a timer.

20. The method according to claim 18, further comprising:
receiving a personal identification code, and wherein the authorizing is further based on the personal identification code.
